(19) United States
(12) Patent Application Publication
(10) Pub. No.: US 2002/0166644 A1
(43) Pub. Date: Nov. 14, 2002

(54) Wing frame

(75) Inventor: Liliana Dronigi, Trieste (IT)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Emilio ANTONINI

(21) Appl. No.: 10/186,036

(22) Filed: Jun. 27, 2002

Related U.S. Application Data
(63) Continuation of application No. PCT/IB00/01907, filed on Dec. 18, 2000.

(30) Foreign Application Priority Data
Dec. 27, 1999 (IT) UD99A000219

(51) Int. Cl. E06B 9/30

(52) U.S. Cl. 160/172 R

(57) ABSTRACT

Wing frame of the type suitable to support a plurality of movable slats (15), comprising at least substantially vertical uprights (14) and substantially horizontal crosspieces (13) and at least a substantially vertical auxiliary profile (12) coupled with at least an upright (14) at an intermediate position between the latter and the heads of the cross-pieces (13) cooperating therewith.

### FIELD OF THE INVENTION

The invention concerns a wing frame suitable to support a plurality of slats which can be directed from a position wherein they prevent light passing to a position wherein they allow more or less light to pass through the wing.

The wing according to the invention is made of wood or other materials, it is applied to the windows, usually inside a room such as an office or a room in a house, and acts both as a frame and as a blind or shutter.

### BACKGROUND OF THE INVENTION

In the field of door and window frames and furnishing accessories, the state of the art includes wings which are applied on the inner side of a window and which comprise a frame on which a plurality of slats—normally horizontal are attached; the slats can be moved from a closed position wherein they prevent the light from passing and a sloping position wherein they allow more or less light to pass inside the room.

The frame normally consists of a plurality of base profiles which respectively function as uprights and crosspieces and are attached to each other, normally at 90°, so as to define the quadrangular shape, generally rectangular, of the frame itself.

This type of conventional frame has various problems, both in construction and in assembly, which considerably affect the final cost and the overall aesthetics of the wing.

When already painted bars are used, the first problem is that at least four profiles are generally used (wing crosspiece, wing upright, box cross-piece and upright, central cross-piece of the wing) which are all different from each other. This entails an accumulation of segments of short material due to the fact that in a standard window the upright is longer than the cross-piece, and that the “short” uprights are practically unusable.

If a single painted bar is used for upright and cross-piece, a second problem is that, because the profiles of uprights and cross-pieces are cut to size according to the size of the window and normally have the same thickness, in the zone where they reciprocally and orthogonally couple, fissures are created in correspondence with the heads, which reveal non-painted zones: the darker the final color of the painted wing, the more obvious this aesthetic defect is.

Another problem is that the size ratio between the width of the bar used for the horizontal sides and that of the vertical sides of the frame is determined by the section size of the profiles, and this affects the overall aesthetics of the wing considerably.

A further disadvantage is that if ornamental patterns, such as a moulding or insert, are applied in view on the frame, this entails working on the profiles which therefore cannot be standardized and pre-defined in large quantities. Moreover, applying possible mechanisms to move the slats also entails, if and when it is possible, working on the profiles which in any case are then visible from the outside.

A further, quite serious problem is that, mainly for aesthetic reasons, the profiles used, particularly for the uprights, must be quite thick and this entails using a large quantity of material, with relative high costs.

The document CH-A-437.729 discloses a metallic frame for a wing comprising uprights, cross-pieces and a plurality of tilting slats. The uprights and the cross-pieces are made of tubular metallic bodies cut at the ends at 45° to couple each other in the corners of the wing.

The frame comprises also, for each upright, an auxiliary profile placed adjacent to the respective upright, but this profile has the same (or less) transversal width of the upright (and of the cross-pieces) and is not inserted in an intermediate position between the relative upright and the heads of the cross-pieces. Further, the auxiliary profile never overlaps the edges of the relative upright and so it cannot have any function to cover unpainted fissures in the zones where cross-pieces and uprights are coupled.

Also document CH-A-503.883 discloses a frame for a wing comprising uprights and cross-pieces cut at the ends at 45° to couple each other in the corners of the wing; the frame comprises also an auxiliary profile which is not inserted in an intermediate position between the relative upright and the heads of the cross-pieces and has not a greater width, both of the uprights and of the cross-pieces, to cover the non-painted fissures which create in the coupling zone.

The present Applicant has devised and embodied this invention to overcome these shortcomings and to obtain further advantages as described hereafter.

### SUMMARY OF THE INVENTION

The invention is set forth and characterized in the main claim, while the dependent claims describe other characteristics of the main embodiment.

The purpose of the invention is to achieve a wing frame suitable to solve the aesthetic and functional problems of the state of the art, with a solution which is economical, easy to achieve and to apply, extremely versatile and substantially universal in use.

In the following description we shall make specific reference to a wing which is substantially quadrilateral in shape, and in particular rectangular or square; however, the teaching of the invention can also be extended to other shapes, for example comprising curved or shaped sections, with three, five or more sides, or other shapes.

According to the invention, a wing frame of the type indicated above comprises at least two substantially vertical uprights, at least two substantially horizontal cross-pieces attached orthogonally to the uprights, and at least a substantially vertical auxiliary profile coupled to one of the uprights at an intermediate position between the upright and the heads of the two cross-pieces cooperating therewith.

In the preferential embodiment of the invention, the frame comprises two auxiliary profiles, each coupled to a relative upright at an intermediate position between every upright and the relative cross-pieces.

In one embodiment of the invention, at least on the side where it is coupled to the relative upright, the auxiliary profile has its transverse section defined by anchoring teeth able to partly enclose and overlap the upright in correspondence with its edges.

In another preferential embodiment of the invention, at least on a substantial part of its extension the transverse section of the auxiliary profile has a width greater than that of the relative uprights and cross-pieces.

Applying the auxiliary profile on a wing of the type described above brings a plurality of advantages both aesthetic and functional.

Firstly, the greater section width compared with the profiles defining the cross-pieces prevents the visible presence of anti-aesthetic, unpainted fissures which are created in the zone where the cross-pieces and uprights are orthogonally coupled when pre-painted profiles, cut transversely to size, are used.

As far as the use of material is concerned, the greater section of the auxiliary profiles and the type of coupling with the respective uprights also brings the considerable advantage in production that, at least for the uprights, it is possible to use elements with a reduced section since they are partly overlapped by said auxiliary profiles.

Thanks to the auxiliary profiles, it is possible to house the elements to move the slats in previously made seatings, so that said elements are hidden; otherwise, these could not be housed, except visibly, in the uprights and crosspieces of the wing.

Since the auxiliary profile is coupled to the relative upright by means of anchoring teeth, this also prevents the wood from shrinking, with time, and from clamping any possible movement means and preventing them from functioning incorrectly. Moreover, it is possible to make transverse holes on the auxiliary profiles, of different diameters to insert toothed crowns of various diameter, or other pins which, connected together, allow the slats to move.

From the aesthetic point of view of the wing, housing and attachment seatings can be provided on the auxiliary profiles for decorative inserts without intervening on the base profiles, which can therefore be supplied by the producer in their finished form; this allows versatility and aesthetic differentiation according to the decorative inserts used.

A further advantage of the auxiliary profiles described above is that they can be used in a production system wherein the base profiles which make up the uprights and cross-pieces are supplied to the installer in a standardized form, all the same, already painted and only to be cut transversely to size; it is possible to diversify the wing with regard to size, with regard to ornamentation/aesthetics and with regard to the relative drive mechanism simply by diversifying the auxiliary profiles alone.

A further advantage of the invention is that it allows to make holes simultaneously in two frames to achieve the holes which allow to house the slats; in this case, one of the two auxiliary profiles can be holed with a through hole and the other with a dead hole to prevent the housing of the hole from being ruined with the through hole.

### BRIEF DESCRIPTION OF THE DRAWINGS

These and other characteristics of the invention will become clear from the following description of a preferential form of embodiment, given as a non-restrictive example, with reference to the attached drawings wherein:

FIG. 1 shows a wing using the frame according to the invention;

FIG. 2 shows an enlarged detail of FIG. 1;

FIG. 3 shows a section from A to A of FIG. 1;

FIG. 4 shows a variant of FIG. 3 wherein a pin for a slat can be inserted;

FIGS. 5a and 5b show a further embodiment of the invention in two different conditions.

### DETAILED DESCRIPTION OF PREFERENTIAL EMBODIMENTS

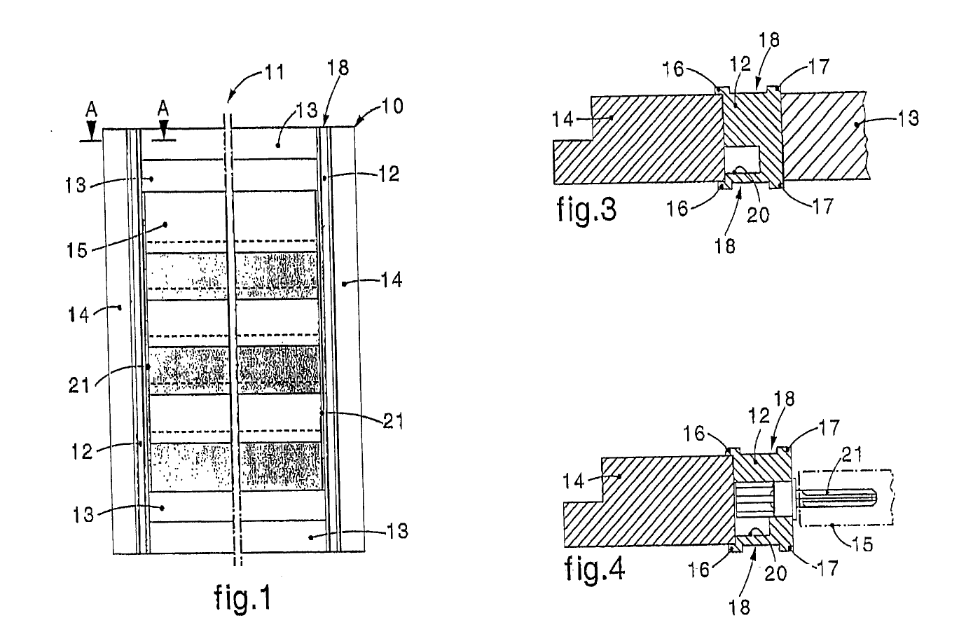

FIG. 1 shows a front view of a wing 11 consisting of a frame 10 comprising two pairs of horizontal cross-pieces 13, respectively upper and lower, two uprights 14 and two auxiliary profiles 12, each coupled to a relative upright 14 at an intermediate position between the upright 14 and the heads of the relative cross-pieces 13.

Between the two opposite and parallel auxiliary profiles 12 a plurality of slats 15 are arranged and transversely anchored; the slats 15 are suitable to be moved from a lowered position wherein they substantially prevent the light from passing through the wing 11 and a sloping position wherein they allow more or less light to pass.

Each of the auxiliary profiles 12 is substantially quadrangular in section (FIGS. 3 and 4) defining, on the side where it couples with a relative upright 14, a pair of anchoring teeth 16 able to cooperate with the edges of the upright 14.

The anchoring teeth 16 facilitate the coupling and centering of the auxiliary profiles 12 and the relative uprights 14, making the grip more stable thereof.

On the opposite side, the profiles 12 have protrusions 17 able to define a greater width value than that of the relative cross-pieces 13, the heads of which are coupled orthogonally with the profiles 12.

Thanks to this greater width, the cut ends of the crosspieces 13 are substantially hidden from sight, and the anti-aesthetic sight of unpainted fissures in correspondence with the 90° coupling zones is eliminated.

Moreover, the partly enclosing and covering configuration determined by the coupling teeth 16 on the respective uprights 14 gives a visual effect which allows to use base profiles with a smaller width, and consequently save material, since all that can be seen is the thickness of the auxiliary profile 12.

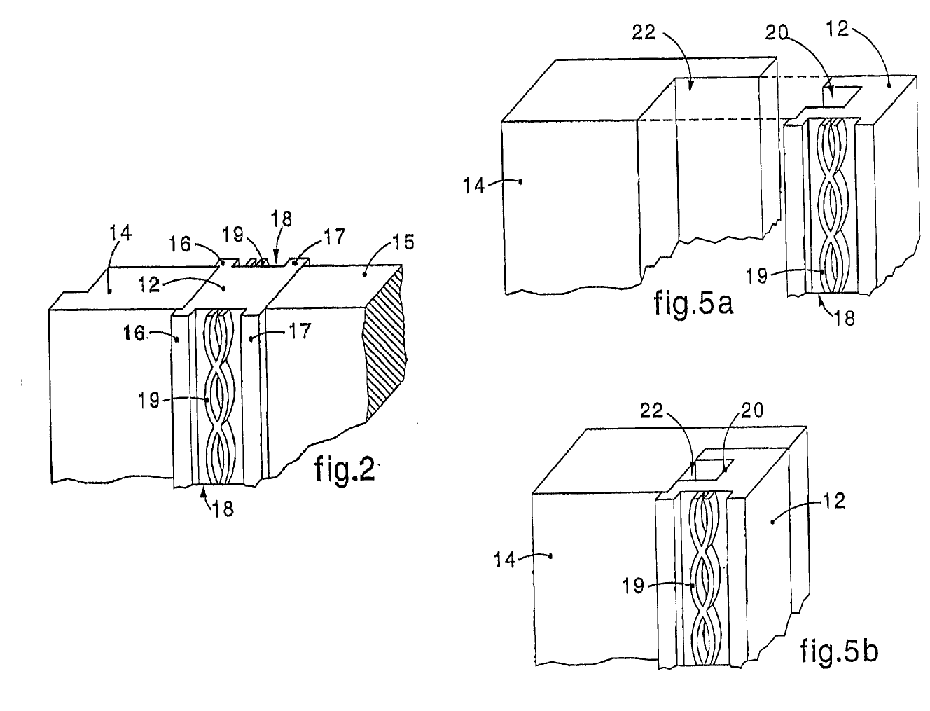

In the embodiment shown in FIG. 2, on both inner and outer sides, the auxiliary profiles 12 have seatings 18 lengthwise, to house inter-changeable decorative inserts 19; the seatings 18 extend substantially for the whole height of the profiles 12.

The decorative inserts 19 are inserted into said seatings 18 and possibly glued or attached thereto in some other way, providing an aesthetic embellishment and personalization for the wing 11.

In this case, the auxiliary profiles 12 have a cavity 20 lengthwise, made for example by milling, into which possible means to move the slats 15 can be inserted; in the embodiment shown in FIG. 4, pins 21 are inserted into the profiles 12, able to be associated with each one of said slats 15 in order to move them.

Thanks to the anchoring teeth 16, the wood of the auxiliary profile 12 does not shrink and does not trap the element to move the slats 15 inside the cavity 20.

Using the auxiliary profiles 12 therefore allows to use standardized profiles, already finished, to make uprights 14 and cross-pieces 13, and then to adapt the wing 11 according to the specific type of application using different profiles 12.

The wing 11 can be personalized by using auxiliary profiles 12 of varying width and shape of section, or by varying the type of decorative insert 19.

Moreover, it is possible to make transverse holes on the profile 12, of a different diameter on each occasion, to allow to house pins 21 with different-sized toothed crowns, or different cavities 20 to house the specific movement means.

In the embodiment shown in FIGS. 5a and 5b, the auxiliary profile 12, equipped with cavities 20 to house the movement means, is coupled to an upright 14 which has a step-type housing groove 22.

The auxiliary profile is anchored to the edge of the upright 14 with its tooth 16, and aesthetically completes the upright, occupying the groove 22 and giving the outer side continuity of line.

It is obvious that modifications or additions may be made to the invention, without departing from the spirit and scope thereof.

1. Wing frame for windows, comprising at least two substantially vertical uprights (14) and at least two substantially horizontal cross-pieces (13), said frame further comprising at least an auxiliary profile disposed adjacent to a relative upright (14) and towards said crosspieces (13), characterized in that said at least one auxiliary profile (12) is disposed in an intermediate position between the heads, cut substantially at 90°, of said cross-pieces (13) and one relative upright (14), said auxiliary profile (21) having a width greater than that of said uprights (14) and of said cross-pieces (13) so as to hide at the sight the fissures which are created in the coupling zones between said heads of the cross-pieces (13) and said relative upright (14).

2. Frame as in claim 1, characterized in that it comprises two auxiliary profiles (12) each disposed adjacent to a relative upright (14) in an intermediate position between said upright (14) and the heads of the relative crosspieces (13).

3. Frame as in claim 1 or 2, characterized in that, at least on the side where it couples with the relative upright (14), said auxiliary profile (12) has one anchoring tooth (16) able to enclose and partly overlap one relative vertical edge of said upright (14).

4. Frame as in claim 1 or 2, characterized in that, at least on the side where it couples with the heads of said cross-pieces (13), said auxiliary profile (12) has protrusions (17) which protrude over the heads of the cross-pieces (13) and hide at the sight the cut ends of said cross-pieces (13).

5. Frame as in claim 1, characterized in that, on at least one of its sides, inner or outer, said auxiliary profile (12) comprises seatings (18) to house decorative inserts (19).

6. Frame as in claim 1, characterized in that said auxiliary profile (12) has a cavity (20) lengthwise to invisibly house means to move said slats (15).

7. Frame as in claim 6, characterized in that said cavity (20) is arranged on the side of the auxiliary profile (12) where it couples with the relative upright (14).

8. Frame as in claim 1, characterized in that it is made with base wood pre-painted profiles all identical in cross-section and cut to size to define uprights (14) and crosspieces (13), the wing (11) being personalized by using different auxiliary profiles (12).
